(19) United States
(12) Patent Application Publication
(10) Pub. No.: US 2014/0372110 A1
(43) Pub. Date: Dec. 18, 2014

(54) VOIC CALL ENHANCEMENT

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/182,189

(22) Filed: Feb. 17, 2014

Related U.S. Application Data
(60) Provisional application No. 61/765,637, filed on Feb. 15, 2013.

(51) Int. Cl. G10L 21/0364; H04M 1/60

(52) U.S. Cl. CPC G10L 21/0364; H04M 1/60
USPC 704/227

(57) ABSTRACT

A Voice Call Enhancement Method for wireless telephonic communication devices includes providing an input voice audio source, enhancing the voice audio input in multiple harmonic and dynamic ranges and outputting the voice enhanced audio. The Voice Call Enhancement method is suitable for use of wireless telephony devices, such as cellular phones. The enhancement includes resynthesizing audio to an increased harmonic and dynamic range than original values.

### CROSS-REFERENCE TO RELATED PATENT APPLICATION

Embodiments of the present invention relate to U.S. Provisional Application Ser. No. 61/765,637, filed Feb. 15, 2013, entitled “VOICE CALL ENHANCEMENT”, the contents of which are incorporated by reference herein and which is a basis for a claim of priority.

### BACKGROUND OF THE INVENTION

Sound quality is typically an assessment of the accuracy, enjoyability, or clarity of audio output from an electronic device. Quality can be measured objectively, such as when tools are used to measure a certain aspect of quality with which the device reproduces an original sound; or it can be measured subjectively, such as when human listeners respond to the sound or gauge its perceived similarity to another sound.¹ ¹ http://en.wikipedia.org/wiki/Sound quality

The sound quality of a reproduction or recording depends on a number of factors, including the equipment used to make it, processing and mastering done to the recording, the equipment used to reproduce it, as well as the listening environment used to reproduce it. In some cases, processing such as equalization, dynamic range compression or stereo processing may be applied to a recording to create audio that is significantly different from the original but may be perceived as more agreeable to a listener. In other cases, the goal may be to reproduce audio as closely as possible to the original.² ² See, n.1, above.

When applied to specific electronic devices, such as loudspeakers, microphones, amplifiers or headphones sound quality usually refers to accuracy, with higher quality devices providing higher accuracy reproduction. When applied to processing steps such as mastering recordings, absolute accuracy may be secondary to artistic or aesthetic concerns. In still other situations, such as recording a live musical performance, audio quality may refer to proper placement of microphones around a room to optimally use room acoustics.³ ³ See, n1, above.

Human voice has a frequency range that extends from 80 Hz to 14 kHz. However, traditional, voice band or narrowband telephone calls limit audio frequencies to the range of 300 Hz to 3.4 kHz. As a result, when humans communicate over telephone lines, there is resulting loss of quality in the voice heard through phone lines due to the loss in the frequency range.

Accordingly, communication devices, such as cellular phones, which rely on limited narrow band widths, have transmission that is very limited in its audio range. Due to this limitation in the available frequency range, manufacturers of telephonic communication devices will only make devices that operate within this criteria. As an example, cell phone manufacturers would not manufacture a full 20 to 20 kHz audio capable phone, as it would not cost efficient since the improvement could not be above what the transmission is capable of.

Due to the limited range of available bandwidth, telecommunication devices that rely on such bandwidth, such as cell phones, utilize electronics and circuitry that have a very narrow frequency range. This limited range results in anything from degraded to garbled voice quality on the receiving user.

There is a need for an application that addresses the above deficiencies of existing systems that can add clarity to received audio.

### SUMMARY OF THE INVENTION

A computer implemented method for enhancing processed voice is provided. According to an embodiment, the inventive process includes receiving voice audio and enhancing the voice audio in multiple harmonic and dynamic ranges. The audio is enhanced by resynthesizing the audio into full range PCM wave. The received voice audio can be in compressed format. The voice audio can be, for example, from an inbound phone call or from an outbound phone call.

### BRIEF DESCRIPTION OF THE DRAWINGS

FIG. 1 is a block diagram of an exemplary embodiment of the Voice Call Enhancement process of the present invention corresponding to an inbound and an outbound call.

FIG. 2 is a block diagram showing the various processing steps of an embodiment of the present invention.

FIG. 3 is an example of the settings corresponding to various processing steps of the present invention for an android application.

### DETAILED DESCRIPTION OF THE PREFERRED EMBODIMENT(S)

The inventive voice enhancement process is used to help clarify both inbound and outbound voice calls on telephonic communication devices. This goal is accomplished by restoring (resynthesizing) the audio to a much greater harmonic and dynamic range than the original audio.

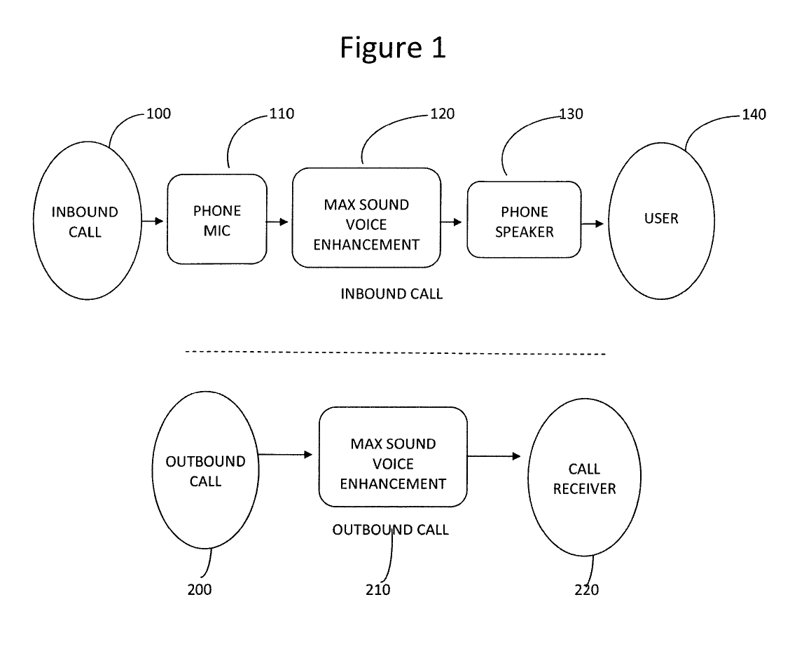

Referring to FIG. 1, with respect to an inbound call 100, user talks into the device 110, where it is received by the voice enhancement module 120. The module 120 resynthesizes the harmonic and dynamic properties of the received audio into a full range PCM (Pulse-code modulation) wave with extended audio content. The result is added clarity to the compressed, band limited audio of the incoming audio. The enhanced voice signal is then received by the phone speaker 130 and transmitted to user 140. With respect to outbound calls 200, user speaks into the device's microphone and, following processing by the inventive voice enhancement module 210, the resulting sound is a clearer, more real sounding wave that is transmitted to the call receiver 220. Advantageously, the transmitted wave retains much of the quality of the original voice, even after being compressed by the cell phone system.

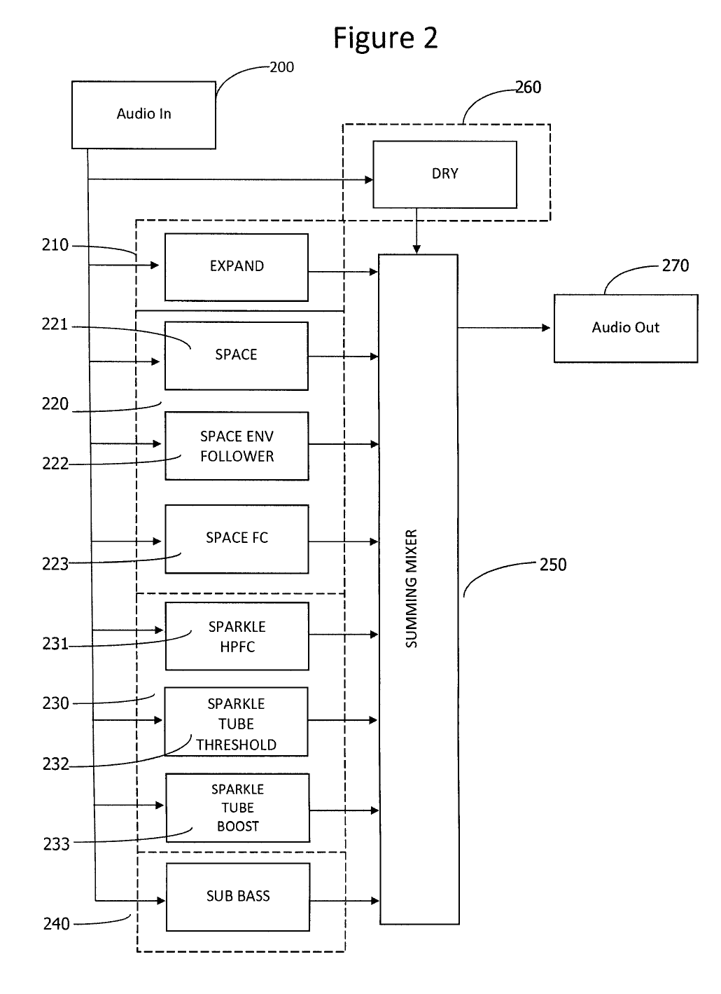

Now the components of the inventive voice call enhancement module (120, 210) according to an exemplary embodiment of the present invention will be explained in greater detail by reference to FIG. 2.

The initial audio signal 200 is subjected to parallel processing by four module processors identified as EXPAND 210, SPACE 220, SPARKLE 230 and SUB PASS 240, and is then combined with the original audio source in a mixer 250. The unprocessed original audio 200 is received by a selector DRY 250, which sets the amount of the original audio source 200 in the mixer. DRY 250 can have a preset control, such as in the range of about 0 to 1, in 0.1 increments.

In more detail, EXPAND 210 is a 4 pole digital low pass filter with an envelope follower for dynamic offset (fixed envelope follower). This allows the output of the filter 210 to be dynamically controlled so that the output level is equal to the input to this filter section. For example, if the level at the input is −6 dB, then the output will match that amount. Moreover, changes at the input level result in the same change to occur at the output in either positive or negative amounts. Preferably, the frequency for this filter 210 is 40K to 20 k hertz, which corresponds to a full range. In one embodiment, the frequency is about 2000 Hertz. The range for EXPAND 210 is 0 to 1, in intervals of 0.1. Optionally, EXPAND 210 is preset in the program. The purpose of this filter 210 is to “warm up” or provide a fuller sound as audio that passes through it. The original sound passes through, and is added to the effected sound for its output. As the input amount increases or decreases (varies), so does the phase of this section. This applies to all filters used in this software application, which, preferably are of the Butterworth type.

The original audio signal 200 is also processed by SPACE 220. SPACE 220 is an envelope controlled bandpass filter and includes three sub processing steps. SPACE 221 corresponds to the output level for this block. SPACE ENV FOLLOWER 222 is the envelope follower modulation amount. SPACE FC 222 corresponds to the frequency range for SPACE 220 block. In one embodiment, the output amplitude for SPACE 220 is between about 0 to 3, preferably about 1.8 and the frequency range for SPACE 220 is between about 1000 to about 8000 Hertz. The settings for SPACE can also be preset.

In more detail, there are several components to SPACE 220. SPACE 221 is the amount is after the envelope follower and sets the final level of this module. This is the processed signal only, without the original. SPACE ENV FOLLOWER 222 tracks the input amount and forces the output level of this section to match. SPACE FC 223 sets the center frequency of the 4 pole digital high pass filter used in this section. This filter also changes phase as does EXPAND 210.

The original audio signal 200 is also processed by SPARKLE 230, which is a high pass filter. FIG. 2 depicts three blocks corresponding to SPARKLE 230. SPARKLE HPFC 231 is the output level for this block which sets HP filter frequency. SPARKLE TUBE THRESHOLD 232 sets the threshold frequency amount of tube simulator sound. The frequency for the high pass filter can be about 4000 to about 10000 Hertz. The tube simulator can be set in single digits from 1-5. The threshold can range from 0-1 in 0.1 intervals. The settings for SPARKLE 230 can also be preset.

In more detail, SPARKLE 230 includes three sub processing steps. SPARKLE HPFC 231 is the output level for this block, which sets HP filter frequency. SPARKLE TUBE THRESH 232 sets the lower level at which the tube simulator begins working. As the input increases, so does the amount of the tube sound. The tube sound is adding harmonics, compression and a slight bit of distortion to the input sound. This amount increases slightly as the input level increases. SPARKLE TUBE BOOST 233 sets amount of tube simulator sound. In one embodiment, the frequency for the high pass filter can be about 4000 to about 10000 Hertz. The tube simulator can be set in single digits from 1-5. The threshold can range from 0 to 1 in 0.1 intervals. The settings for SPARKLE can also be preset.

The original audio signal 200 is also processed by SUB BASS 240, which operates to add an amount of dynamic synthesized sub bass to the audio. In one embodiment, the frequency of the subpass is about 120 Hz to less. In more detail, SUB BASS 240 operates on the input signal 200 and uses a low pass filter to set the upper frequency limit to about 100 Hz. An octave divider occurs in the software that changes the input signal to lower by an octave (12 semi tones) and output to the only control in the interface, which is the level or the final amount. This is the effected signal only, without the original.

Processed audio from the above modules are fed into a summing mixer 250 which combines the audios. The levels going into the summing mixer are controlled by the various outputs of the modules listed above. As they all combine with the unprocessed original signal 260, there is interaction in phase, time and frequencies that occur dynamically. These changes all combine to create a very pleasing audio experience for the listener in the form of “enhanced” audio content. For example, a change in a single module can have a great affect on what happens in relation to the other modules final sound or the final harmonic output of the entire software application.

This process can be a small program or API for use in any smart phone format for fixed processor or for floating point processors, or used in any device that needs voice enhancement or clarity.

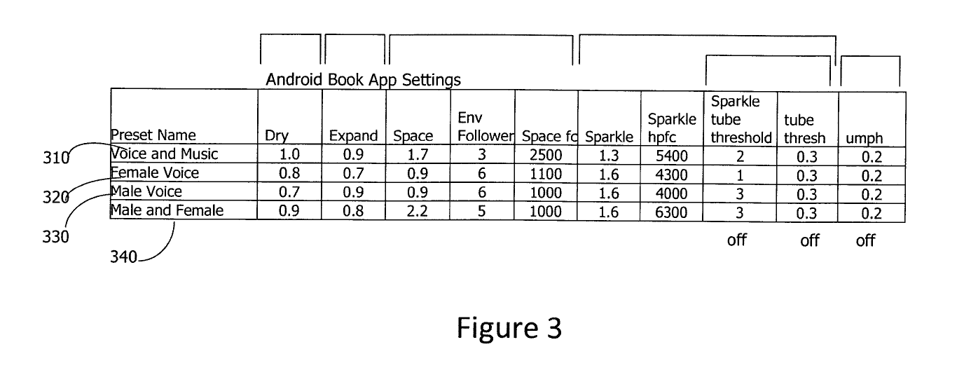

FIG. 3 is a table that illustrates an example of a setting for an android application according to an embodiment of the present invention. The table shows various settings corresponding to some of the processing modules of FIG. 2 for Voice and Music 310, Female Voice 320, Male Voice 330 and Male and Female 340.

What is claimed is:

1. A voice call enhancement process Method for wireless telephonic communication devices comprising:
Providing an input voice audio source;
Enhancing the voice audio input in two or more harmonic and dynamic ranges by resynthesizing the audio into a full range PCM wave;
Outputting the voice enhanced audio.

2. The Voice Call Enhancement Method of claim 1 wherein the wireless communication device is a cellular phone.

3. The Voice Call Enhancement Method of claim 1 wherein the enhancement includes resynthesizing audio to an increased harmonic and dynamic range than original values.

4. The Voice Call Enhancement Method of claim 1, wherein the enhancement includes the parallel processing the input audio as follows:
A module that is a low pass filter with dynamic offset;
An envelope controlled bandpass filter;
A high pass filter;
Adding an amount of dynamic synthesized sub bass to the audio;
Combining the four treated audio signals in a summing mixer with the original audio.
